(19) United States
(12) Patent Application Publication
(10) Pub. No.: US 2026/0302677 A1
(43) Pub. Date: Oct. 1, 2026

(54) Display Connector

(71) Applicant: Tyco Electronics AMP Korea Co., Ltd., Gyeongsan (KR)

(72) Inventors: Byung-Hee Cho, Gyeongsan-Si (KR); Sung-Chul Kim, Gyeongsan-Si (KR)

(73) Assignee: Tyco Electronics AMP Korea Co., Ltd., Gyeongsan (KR)

(21) Appl. No.: 19/577,498

(22) Filed: Mar. 25, 2026

(30) Foreign Application Priority Data
Mar. 25, 2025 (KR) 10-2025-0038301
Mar. 26, 2025 (KR) 10-2025-0010882
Mar. 26, 2025 (KR) 10-2025-0010883
Mar. 26, 2025 (KR) 10-2025-0010884
Jan. 29, 2026 (KR) 10-2026-0018139

(51) Int. Cl. H01R 13/436; H01R 12/71

(52) U.S. Cl. CPC H01R 13/4361; H01R 12/716

(57) ABSTRACT

A display connector includes a header assembly, a tab terminal, and a receptacle assembly. The header assembly has a plug housing and a peg terminal. The plug housing accommodates a plug-side terminal. The peg terminal is provided in the plug housing and is coupled to a printed circuit board (PCB). The tab terminal is electrically coupled to the plug-side terminal. The receptacle assembly has a cap housing and a terminal position assurance (TPA) member. The cap housing is coupled to the header assembly and accommodates the tab terminal. The TPA member is provided in the cap housing and prevents misassembly and terminal displacement of the tab terminal.

### CROSS-REFERENCE TO RELATED APPLICATIONS

This application claims the benefit of the filing date under 35 U.S.C. § 119(a)-(d) of Korean Patent Application Nos. 10-2025-0038301, filed on Mar. 25, 2025, 10-2025-0010882, filed on Mar. 26, 2025, 10-2025-0010883, filed on Mar. 26, 2025, 10-2025-0010884, filed on Mar. 26, 2025, and 10-2026-0018139, filed on Jan. 29, 2026, in the Korean Intellectual Property Office, the entire disclosures of which are incorporated herein by reference for all purposes.

### FIELD OF THE INVENTION

The present invention relates to a connector and, more particularly, to a display connector.

### BACKGROUND OF THE INVENTION

Various electrical connectors are used in the electrical field. For example, a cordless cleaner includes a connector for applying power to a display to display a state of the cleaner. In this case, a display connector of the cordless cleaner is assembled together with a filter unit due to a spatial restriction, and thus, the cordless cleaner has a structure for repeated assembly and disassembly of the cordless cleaner. Accordingly, the display connector may require a structure that is easy to assemble and disassemble and a structure for preventing misassembly during repeated assembly and disassembly.

The above description is information the inventor(s) acquired during the course of conceiving the present disclosure, or already possessed at the time, and was not necessarily publicly known before the present application is filed.

### SUMMARY OF THE INVENTION

A display connector includes a header assembly, a tab terminal, and a receptacle assembly. The header assembly has a plug housing and a peg terminal. The plug housing accommodates a plug-side terminal. The peg terminal is provided in the plug housing and is coupled to a printed circuit board (PCB). The tab terminal is electrically coupled to the plug-side terminal. The receptacle assembly has a cap housing and a terminal position assurance (TPA) member. The cap housing is coupled to the header assembly and accommodates the tab terminal. The TPA member is provided in the cap housing and prevents misassembly and terminal displacement of the tab terminal.

### BRIEF DESCRIPTION OF DRAWINGS

The invention will now be described by way of example with reference to the accompanying figures, of which:

FIG. 1 is a perspective view of a display connector assembled on a printed circuit board (PCB) according to an embodiment;

FIG. 2 is a cross-sectional view of the display connector of FIG. 1;

FIG. 3 is a perspective view of a header assembly in a direction in the display connector of FIG. 1;

FIG. 4A is a side view of a cap housing of the display connector of FIG. 1, where a terminal position assurance (TPA) member is closed;

FIG. 4B is a side view of the cap housing of FIG. 4A illustrating a reopening operation of the TPA member of FIG. 4A; and

FIG. 5 is a perspective view of a tab terminal according to an embodiment.

### DETAILED DESCRIPTION

Hereinafter, embodiments are described in detail with reference to the accompanying drawings. However, various alterations and modifications may be made to the embodiments. Here, the embodiments are not construed as limited to the disclosure. The embodiments should be understood to include all changes, equivalents, and replacements within the technical scope of the disclosure.

The terminology used herein is for the purpose of describing particular embodiments only and is not to be limiting of the embodiments. As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the examples belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components regardless of drawing numbers and a repeated description related thereto will be omitted. In the description of embodiments, detailed description of well-known related technology will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

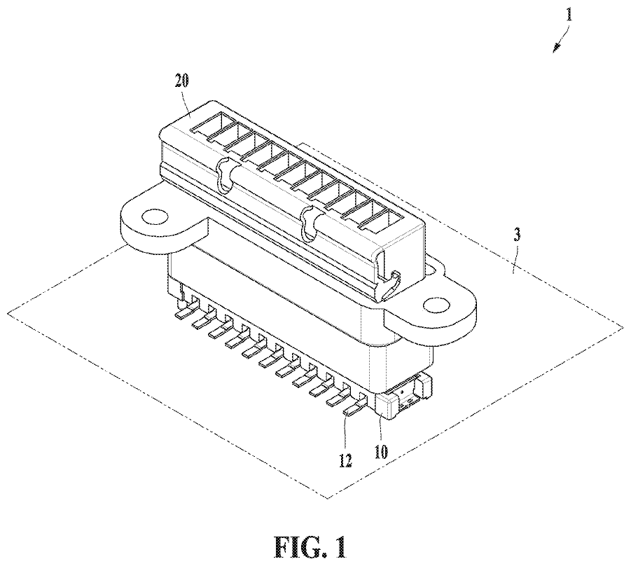

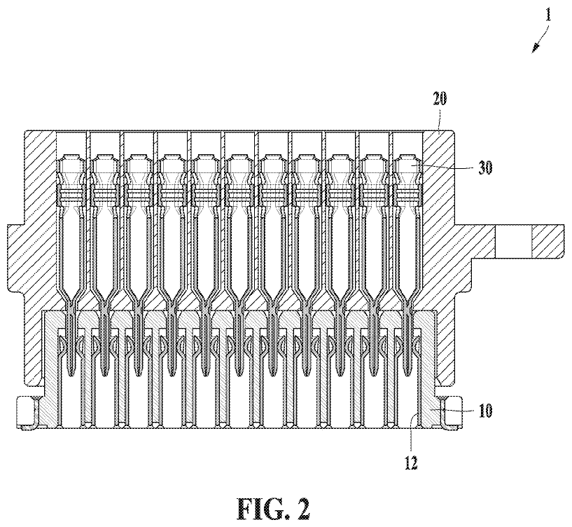

An exemplary embodiment of a display connector 1 will now be described with reference to FIGS. 1-5. As shown in FIG. 2, the display connector 1 may include a header assembly 10, a receptacle assembly 20, and a tab terminal 30.

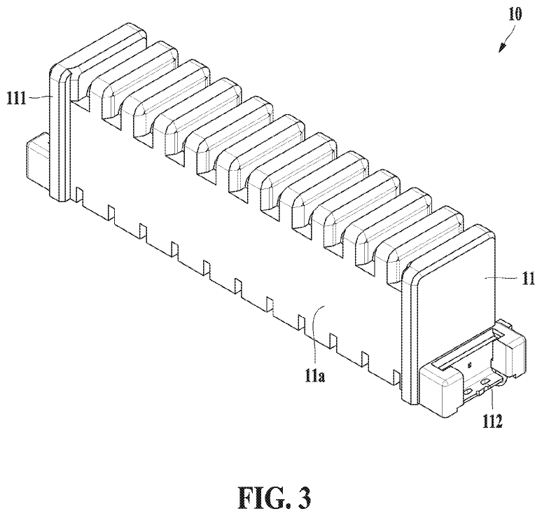

The header assembly 10 may include a plug housing 11, as shown in FIG. 3, that accommodates a plurality of plug-side terminals 12, as shown in FIGS. 1-2. A key code 111 for guiding an assembly direction of the plug-side terminal 12 may be formed on one surface (hereinafter, also referred to as a “first surface”) 11a of the plug housing 11. For example, referring to FIG. 3, on the first surface 11a of the plug housing 11, an edge portion of the key code 111 may protrude more than the first surface 11a. In this case, the plug housing 11 may be provided to expose the plug-side terminal 12 in an opposite direction of the first surface 11a. As described above, since the direction of the plug housing 11 is distinguished according to the formation of the key code 111 and the assembly direction of the plug-side terminal 12 is guided, misassembly of the plug-side terminal 12 may be prevented.

Although the drawing illustrates that the key code 111 is formed in the opposite direction of the direction in which the plug-side terminal 12 is exposed, this is an example, and the position of the key code 111 is not limited to the drawings. In other words, if the key code 111 is able to guide the assembly direction of the plug-side terminal 12 and prevent misassembly, the key code 111 may be formed at substantially various positions in the plug housing 11, and the shape of the key code 111 may also vary.

As shown in FIG. 3, a peg terminal 112 may be provided on one side of the plug housing 11 to improve a coupling force to a printed circuit board (PCB) 3. For example, the peg terminals 112 may be formed on both sides of the plug housing 11. In addition, when the plug housing 11 is mounted on the PCB 3, the peg terminal 112 may be formed on a lower part of the side surface of the plug housing 11 such that the peg terminal 112 is coupled to the PCB 3.

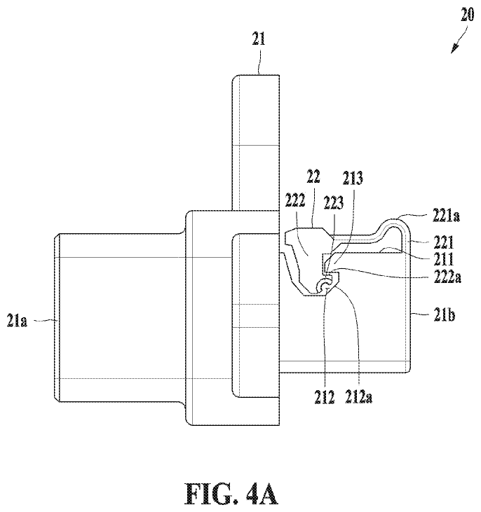

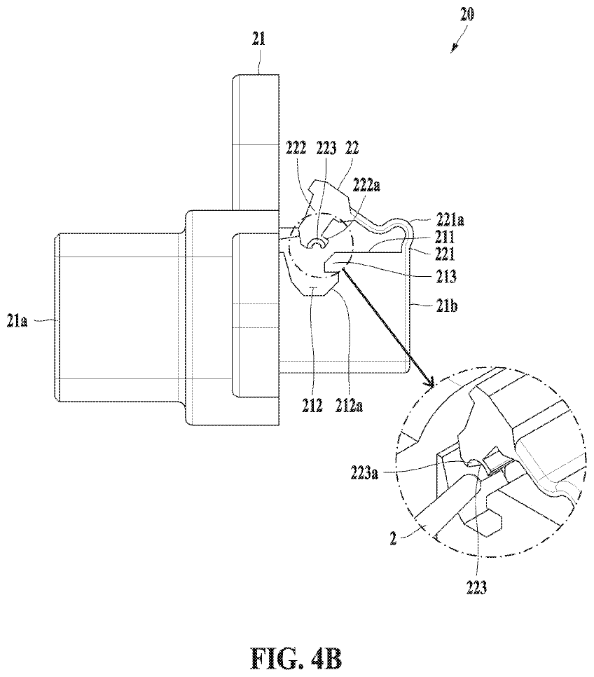

As shown in FIGS. 4A-4B, the receptacle assembly 20 may include a cap housing 21 that accommodates a plurality of tab terminals 30. An end portion of the cap housing 21 in a direction coupled to the header assembly 10 may be referred to as a first end portion 21a, and an end portion opposite to the first end portion 21a may be referred to as a second end portion 21b. In addition, the tab terminal 30 may be fitted into the second end portion 21b.

As shown in FIGS. 4A-4B, a terminal position assurance (TPA) member 22 may be provided at the second end portion 21b of the cap housing 21 to determine whether the tab terminal 30 is assembled in a correct position and whether there is a misassembly or terminal displacement. A coupling groove 212 engaged with and coupled to the TPA member 22 may be formed on a first surface 211 of the cap housing 21. The coupling groove 212 may cause the tab terminal 30 accommodated in the cap housing 21 to be in contact with the TPA member 22 to determine whether the tab terminal 30 is assembled in the correct position. The determination of misassembly and terminal displacement of the tab terminal 30 is described below.

As shown in FIGS. 4A-4B, a locking bump 213 may be formed in the coupling groove 212 to allow the TPA member 22 to be engaged with and coupled to the locking bump 213. In this case, the locking bump 213 may be formed at an opening edge of the coupling groove 212 and may protrude in a direction opposite to a coupling direction of the TPA member 22, in other words, in a direction opposite to a hinge portion 221 of the TPA member 22.

As shown in FIGS. 4A-4B, the TPA member 22 may include the hinge portion 221 and a head 222. The head 222 may be formed as a free end and may extend in a cantilever shape from the hinge portion 221. In the hinge portion 221, an end portion of the TPA member 22 may be fixed to the second end portion 21b of the cap housing 21, and the hinge portion 221 may hingedly rotate relative to the cap housing 21. In this case, the hinge portion 221 may include a movable portion 221a having elasticity and enabling hinge rotation at a portion adjacent to the fixed portion to the cap housing 21. For example, a portion of the movable portion 221a starting from the fixed portion may be formed with a predetermined curved surface. In addition, the movable portion 221a may be formed with a constant thickness. According to the embodiments, stress generated due to hinge rotation in the TPA member 22 may be distributed by forming the movable portion 221a with the curved surface and constant thickness. In addition, a total length of the hinge portion 221 and the TPA member 22 may be minimized by forming the movable portion 221a with the curved surface having a roughly circular cross-section.

In addition, as shown in FIGS. 4A-4B, the movable portion 221a may be formed upward at a predetermined height from the first surface 211 of the cap housing 21. By forming the movable portion 221a as described above, the TPA member 22 may be spaced apart from the first surface 211 of the cap housing 21 by the predetermined height.

As shown in FIGS. 4A-4B, the head 222 may be formed at the other end of the TPA member 22 and may be formed to be engaged with and coupled to the coupling groove 212 as the head 222 is inserted into the coupling groove 212. In the head 222, an engagement portion 222a may be formed to allow the head 222 to be engaged with and be coupled to the locking bump 213 of the coupling groove 212 as the head 222 is inserted into the coupling groove 212. For example, the engagement portion 222a may protrude toward the locking bump 213.

In this case, when pressing the head 222 with force, the head 222 may be hingedly rotated by the hinge portion 221, and the TPA member 22 may be inserted into the coupling groove 212. In this case, in the TPA member 22, since the movable portion 221a is elastic, when force is applied to the head 222, the head 222 may flexibly pass over the locking bump 213 and may be inserted into the coupling groove 212. A state in which the head 222 is inserted into the coupling groove 212 as described above may be referred to as a closed state or locked state of the TPA member 22. In the closed state of the TPA member 22, while the engagement portion 222a is engaged with the locking bump 213, an elastic restoring force by the movable portion 221a may maintain the engagement portion 222a in contact with the locking bump 213, thereby preventing the TPA member 22 from opening.

As shown in FIGS. 4A-4B, a reopening groove 223 may be formed in the TPA member 22 to reopen the TPA member 22 in the closed state when the tab terminal 30 is incorrectly assembled or needs to be reassembled. The reopening groove 223 may be formed in a lower direction of the engagement portion 222a and may have a semi-cylindrical shape to insert an opening tool 2 (e.g., a common awl) therein. In addition, when the opening tool 2 is inserted into the reopening groove 223, the reopening groove 223 may be formed to cause a force applied by the opening tool 2 to be exerted in a direction in which the engagement portion 222a is deviated from the locking bump 213.

For example, the reopening groove 223 may be formed concavely on a surface in which an edge portion of the head 222 in a lower direction of the engagement portion 222a is chamfered and may have a cylindrical shape in the width direction of the cap housing 21 in the head 222. When the opening tool 2 is inserted into the reopening groove 223, the reopening groove 223 may be formed such that a force applied by the opening tool 2 to the head 222 is exerted in the direction in which the engagement portion 222a is deviated from the locking bump 213 (in other words, in a diagonally forward and upward direction).

When the opening tool 2 is inserted into the reopening groove 223, as the force is applied to the head 222 in a curved direction of the reopening groove 223, the engagement portion 222a may be deviated from the locking bump 213, and the head 222 may be deviated from the coupling groove 212, thereby opening the TPA member 22.

A chamfered portion 223a, as shown in FIG. 4B, that is an inclined surface in a direction in which the opening tool 2 enters may be formed around both end portions of the reopening groove 223. For example, the chamfered portion 223a may be formed with a predetermined inclined surface or a curved surface with inclination with respect to the direction in which the opening tool 2 enters.

In this case, in the present embodiment, to easily reopen the TPA member 22, a portion corresponding to the reopening groove 223 in the coupling groove 212 may be formed with an inclined surface 212a corresponding to the inclination of the surface on which the reopening groove 223 is formed.

In addition, the chamfered portion 223a may be formed around the both end portions of the reopening groove 223. The chamfered portion 223a may be formed at a starting portion of the reopening groove 223 on the side of the head 222 and may be formed with a curved surface or inclined surface that is formed to be inclined with respect to the direction in which the opening tool 2 enters the reopening groove 223. According to the present embodiment, since the chamfered portion 223a is formed at the end portion of the reopening groove 223, the opening tool 2 may be smoothly inserted into the reopening groove 223.

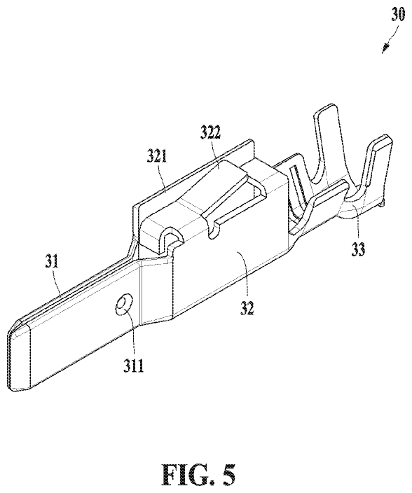

The tab terminal 30, as shown in FIG. 5, may include a contact portion 31 electrically in contact with the plug-side terminal 12, and a barrel portion 33 coupled to a body 32 and a wire.

In the tab terminal 30, a dimple 311, as shown in FIG. 5, may be formed at the contact portion 31 to guide a position at which the tab terminal 30 is assembled to the cap housing 21. Since the dimple 311 is formed at the contact portion 31, when a plurality of tab terminals 30 are assembled to the cap housing 21, the assembled position may be constant. However, the drawing is an example for description, and various components may be formed other than the dimple 311 to maintain the assembled position of the tab terminal 30 to be constant.

In the tab terminal 30, a locking lance 322, as shown in FIG. 5, may be formed to be fastened to the cap housing 21. For example, the locking lance 322 may protrude in an outer direction as a portion of the body 32 is cut. In addition, the locking lance 322 may protrude such that the tab terminal 30 is deviated from the body 32 toward the rear with respect to a direction in which the tab terminal 30 is inserted into the cap housing 21. According to the present embodiment, the locking lance 322 may serve to fasten the tab terminal 30 to the cap housing 21 by forming the locking lance 322 in the tab terminal 30, thereby simplifying the structure of the cap housing 21.

As shown in FIG. 5, in addition, a misassembly prevention guide 321 may be formed in the tab terminal 30 to prevent misassembly of the tab terminal 30 to the body 32. In the misassembly prevention guide 321, one side of the body 32 may extend longer than the other portion. In addition, in the misassembly prevention guide 321, an edge of the surface on which the locking lance 322 is formed may extend in the same direction as a direction in which the locking lance 322 protrudes (in the drawings, the upper direction). In addition, the misassembly prevention guide 321 may extend at the same height as the height at which the locking lance 322 protrudes from the body 32. In this case, the tab terminal 30 may be formed by bending a single plate, and the misassembly prevention guide 321 may be integrally formed with the body 32 while forming the body 32 without a separate process.

The misassembly and terminal displacement of the tab terminal 30 of the TPA member 22 will now be described.

Inside the coupling groove 212, in the TPA member 22, the head 222 may be in contact with the tab terminal 30. In this case, when the the tab terminal 30 is installed in a correct position of the cap housing 21, the head 222 may be fully inserted into the coupling groove 212, and the TPA member 22 may be fully closed. However, when there is a misassembly or terminal displacement as the tab terminal 30 is installed upside down or is not installed in the correct position, interference between the head 222 and the tab terminal 30 may occur in the coupling groove 212, and accordingly, the head 222 may not be fully inserted into the coupling groove 212. Accordingly, when closing the TPA member 22, the misassembly or terminal displacement of the tab terminal 30 may be determined based on whether the head 222 is fully inserted into the coupling groove 212. In addition, when the tab terminal 30 is assembled in the correct position, in the TPA member 22, the head 222 may be positioned in a direction opposite to the direction in which the tab terminal 30 is deviated from the cap housing 21, and the force may be applied to the head 222 in the coupling groove 212, and accordingly, the tab terminal 30 may be prevented from being deviated from the cap housing 21. In addition, when the tab terminal 30 is pushed, the head 222 may press the tab terminal 30 in the coupling groove 212 to push the tab terminal 30 into the correct position by closing the TPA member 22, thereby preventing the tab terminal 30 from being deviated from the correct position and maintaining the tab terminal 30 in the correct position.

According to the embodiments, since the peg terminal 112 is provided in the plug housing 11, the header assembly 10 may have a great coupling force to the PCB 3. In addition, the plug housing 11 may prevent misassembly of the plug-side terminal 12 as the key code 111 is formed. Since the TPA member 22 is provided, the cap housing 21 may prevent misassembly or terminal displacement of the tab terminal 30. In addition, since the reopening groove 223 is formed in the TPA member 22, the TPA member 22 may be easily reopened using the opening tool 2 when necessary.

In the aforementioned exemplary embodiments according to the present invention, the display connector 1 has a structure that is easy to assemble and disassemble and a structure for preventing misassembly during repeated assembly and disassembly. According to an aspect, the display connector 1 may be for a cordless cleaner. The display connector 1 includes the peg terminal 112 in the plug housing 11 to improve a coupling force to the PCB 3 and includes the TPA member 22 in the cap housing 21 to prevent misassembly and terminal displacement of the tab terminal 30.

The effects of the display connector 1 according to an embodiment are not limited to the above-mentioned effects, and other unmentioned effects may be clearly understood from the following description by one of ordinary skill in the art.

The technical aspects obtainable from the present disclosure are non-limited by the above-mentioned technical aspects, and other unmentioned technical aspects can be clearly understood from the following description by those having ordinary skill in the technical field to which the present disclosure pertains.

Although the embodiments are described with reference to the limited drawings, one of ordinary skill in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Accordingly, other implementations are within the scope of the following claims.

1. A display connector comprising:
a header assembly having a plug housing and a peg terminal, the plug housing accommodates a plug-side terminal, the peg terminal is provided in the plug housing and is coupled to a printed circuit board (PCB);
a tab terminal electrically coupled to the plug-side terminal; and
a receptacle assembly having a cap housing and a terminal position assurance (TPA) member, the cap housing is coupled to the header assembly and accommodates the tab terminal, the TPA member is provided in the cap housing and prevents misassembly and terminal displacement of the tab terminal.

2. The display connector of claim 1, wherein a key code preventing misassembly of the plug-side terminal is formed on one surface of the plug housing.

3. The display connector of claim 2, wherein the plug-side terminal is assembled to a lower surface of the plug housing, and the key code is formed on a side surface of the plug housing to guide an assembly direction of the plug-side terminal.

4. The display connector of claim 1, wherein the peg terminal is provided on both side surfaces of the plug housing such that the peg terminal is coupled to the PCB when the plug housing is mounted on the PCB.

5. The display connector of claim 1, wherein the TPA member has a hinge portion and a head.

6. The display connector of claim 5, wherein the hinge portion hingedly rotates relative to the cap housing, the hinge portion is formed at one end of the TPA member coupled to the cap housing.

7. The display connector of claim 6, wherein the head, in which an engagement portion is formed at an other end of the TPA member, extends in a cantilever shape from the hinge portion, the engagement portion is engaged with and is coupled to a coupling groove formed in the cap housing.

8. The display connector of claim 7, wherein the hinge portion has a movable portion, the movable portion is formed with a curved surface and has elasticity at a portion adjacent to a portion fixed to the cap housing.

9. The display connector of claim 8, wherein the hinge portion is formed with a constant thickness.

10. The display connector of claim 7, wherein the TPA member has a reopening groove, the reopening groove is formed in a lower direction of the engagement portion in the head, the reopening groove reopens the TPA member such that the TPA member is deviated from the coupling groove as an opening tool is inserted into the reopening groove.

11. The display connector of claim 10, wherein the reopening groove is formed concavely on an inclined surface that is formed by chamfering an edge portion in the lower direction of the engagement portion, the reopening groove applies a force in a direction in which the engagement portion is deviated from the coupling groove when the opening tool is inserted into the reopening groove.

12. The display connector of claim 11, wherein the reopening groove has a chamfered portion, the chamfered portion is inclined with respect to a direction in which the opening tool enters and is formed around the reopening groove on a side surface of the head.

13. The display connector of claim 1, wherein a locking lance fastened to the cap housing is formed in a body of the tab terminal.

14. The display connector of claim 13, wherein the locking lance protrudes in an outer direction as a portion of the body is cut.

15. The display connector of claim 14, wherein the tab terminal has a misassembly prevention guide preventing misassembly of the tab terminal.

16. The display connector of claim 15, wherein the misassembly prevention guide is formed in the body, and in the misassembly prevention guide, the portion of the body extends in a same direction as a direction in which the locking lance protrudes.

17. The display connector of claim 16, wherein a height at which the misassembly prevention guide protrudes from the body is the same as a height at which the locking lance protrudes.

18. The display connector of claim 14, wherein the tab terminal has a dimple, the dimple is formed at a contact portion that is electrically in contact with the plug-side terminal to maintain a constant position at which a plurality of tab terminals is assembled to the cap housing.

19. The display connector of claim 13, wherein the tab terminal has a barrel portion coupled to the body.
